(19) United States
(12) Patent Application Publication
(10) Pub. No.: US 2013/0031625 A1
(43) Pub. Date: Jan. 31, 2013

(54) CYBER THREAT PRIOR PREDICTION APPARATUS AND METHOD

(71) Applicant: Sun Hee LIM, Seongnam (KR)

(72) Inventor: Sun Hee LIM, Seongnam (KR)

(73) Assignee: Electronics and Telecommunications Research Institute, Daejeon (KR)

(21) Appl. No.: 13/451,375

(22) Filed: Apr. 19, 2012

(30) Foreign Application Priority Data
Jul. 29, 2011 (KR) 10-2011-0076092
Oct. 10, 2011 (KR) 10-2011-0103255

(51) Int. Cl. G06F 21/00

(52) U.S. Cl. 726/22

(57) ABSTRACT

Disclosed are a cyber threat prior prediction apparatus, including a DNS based C&C server detecting unit configured to analyze DNS traffic to extract a domain address which is suspected as a C&C server; a network based abnormality detecting unit configured to analyze the network traffic to detect IP addresses of zombie PCs which access the C&C server and information of the zombie PCs; and a cyber threat predicting unit configured to predict a cyber threat situation based on the information of the zombie PCs.

### CROSS-REFERENCE TO RELATED APPLICATIONS

This application claims priority to and the benefit of Korean Patent Application No. 10-2011-0076092 and 10-2011-0103255 filed in the Korean Intellectual Property Office on Jul. 29, 2011 and Oct. 10, 2011, the entire contents of which are incorporated herein by reference.

### TECHNICAL FIELD

The present invention relates to a cyber threat prior prediction apparatus based on a botnet and a method thereof.

### BACKGROUND ART

Currently, threats have become an issue in a cyber space. Threats on the Internet such as extortion or collection of personal information from a third party for misuse, seeking of financial profit by spreading pornographic or commercial mails to unspecified people or incapacitating of service of information machine of a competitor have unfortunately become common practice.

Recently, TMS (threat management system) and RMS (risk management system) technologies that detect threats on the Internet in advance by analyzing vulnerability information and domestic and foreign network traffic to provide a security policy setting criteria and a copying method thereof by early warning/forecasting have been studied. The TMS/RMS technologies are emerging as efficient alternatives that overcome the disadvantages of known security solutions. However, the TMS/RMS technologies focus on forecasting/warning threats on the Internet based on information on an attack situation that has been already occurred. Therefore, it is difficult to differentiate between the TMS/RMS technologies and the known security solutions. Further, the TMS/RMS technologies have a limitation in providing a local security solution. Therefore, it is difficult to utilize the TMS/RMS technologies as a solution that previously recognizes the threat situation before the actual attack is generated in the entire area. 60% or more cyber threats such as DDoS (distributed denial of service) attack, spam transmission, or extortion of personal information which are recently frequently generated in cyberspace are performed through a botnet.

The botnet refers to a network of a plurality of computers that are infected by a bot, which is malignant software. In other words, thousands to hundreds of thousands computers which are infected by bots (also referred to as zombies) and remotely controlled by a bot master having an authority that freely controls the bots and perform various malignant activities are connected to a C&C (command and control) server that issues commands and control instructions through a network.

An initial stage of botnet is mainly a botnet having a centralized structure that uses an IRC (internet relay chat) having a flexible structure and widely used. In the botnet having the centralized structure, since one C&C server commands and controls a plurality of bots, it is easy to detect the C&C server. Further, a plurality of bots are lost due to the detection and shutting down of C&C server, which gives a big damage to an attacker. Therefore, the botnet is evolved to a distributed command/control method, that is, P2P botnet that is based on HTTP, which is a web protocol, or allows the all of zombies to be C&Cs rather than the centralized command/control structure (IRC, HTTP botnet) in order to make it more difficult to detect the C&C server and cope with attacks.

This kind of advanced botnet causes serious threats of assets in addition to serious attacks such as DDoS attack, spam transmission, or extortion of personal information.

### SUMMARY OF THE INVENTION

The present invention has been made in an effort to provide a cyber threat prior prediction apparatus that determines the botnet which is mass attack means for cyber threats as a portent of cyber threats and predicts the threats before the attack on a large scale is actually generated over a global network and a method thereof.

An exemplary embodiment of the present invention provides a cyber threat prior prediction apparatus, including: a DNS based C&C server detecting unit configured to analyze DNS traffic to extract a domain address which is suspected as a C&C server; a network based abnormality detecting unit configured to analyze the network traffic to detect IP addresses of zombie PCs which access the C&C server and information of the zombie PCs; and a cyber threat predicting unit configured to predict a cyber threat situation based on the information of the zombie PCs.

The network based abnormality detecting unit may be installed in an international gateway network.

The DNS based C&C server detecting unit may analyze the DNS traffic based on a domain address, traffic characteristics, or N-tier.

The network based abnormality detecting unit may detect access information of the zombie PCs to the C&C server.

The network based abnormality detecting unit may verify the C&C server based on the access information of the zombie PCs to the C&C server.

The network based abnormality detecting unit may detect network structure based threat information and activity based threat information of the zombie PCs.

The network structure based threat information may include a bot size, an access frequency of bots, or the number of bots which are propagated to the ISP domains.

The activity based threat information may include a spam attack activity, a scan attack activity, a binary download activity, or an exploiting activity.

The cyber threat predicting unit may predict a cyber threat situation based on the network structure based threat information and the activity based threat information.

The cyber threat predicting unit may calculate a threat index quantified based on the network structure based threat information and the activity based threat information and predicts the cyber threat situation using the quantified threat index.

Another exemplary embodiment of the present invention provides a cyber threat prior prediction method, including: analyzing DNS traffic to extract a domain address which is suspected as a C&C server; analyzing network traffic to detect IP addresses of zombie PCs which access the C&C server and information of the zombie PCs; and predicting a cyber threat situation based on the information of the zombie PCs.

The detecting of information of zombie PCs may analyze network traffic of an international gateway network.

The detecting of information of zombie PCs may include detecting access information of the zombie PCs to the C&C server.

The detecting of information of zombie PCs may include verifying the C&C server based on access information of the zombie PCs to the C&C server.

The detecting of information of zombie PCs may include detecting network structure based threat information and activity based threat information of the zombie PCs.

The predicting of cyber threat situation may include predicting the cyber threat situation based on the network structure based threat information and the activity based threat information.

The predicting of cyber threat situation may include: calculating a threat index quantified based on the network structure based threat information and the activity based threat information; and predicting the cyber threat situation using the quantified threat index.

According to exemplary embodiments of the present invention, it is possible to determine the botnet which is mass attack means for cyber threats as a portent of cyber threats and predict the threats before the attack on a large scale is actually generated over a global network.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 shows an example of a botnet structure according to an exemplary embodiment of the present invention.

FIG. 2 shows a configuration of a cyber threat prior prediction apparatus according to an exemplary embodiment of the present invention.

FIG. 3 shows a more specific configuration of a cyber threat prior prediction apparatus according to an exemplary embodiment of the present invention.

FIG. 4 is a flowchart of a cyber threat prior prediction method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

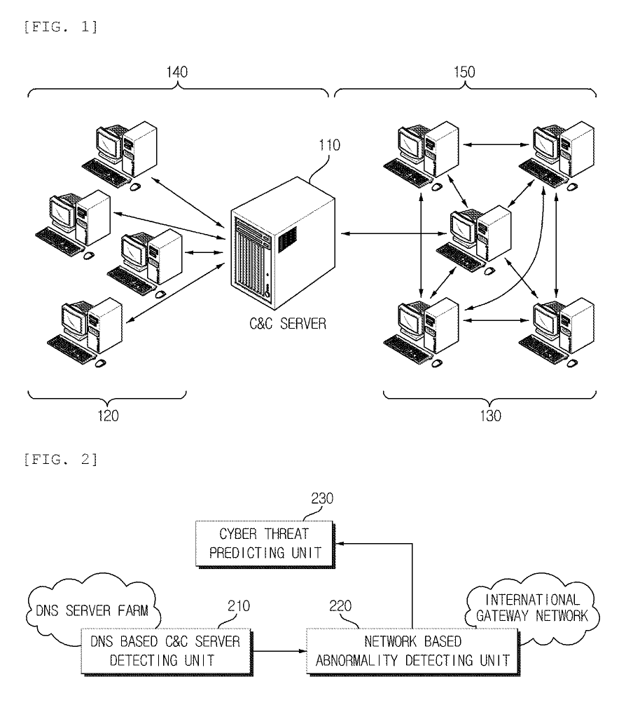

FIG. 1 shows an example of a botnet structure according to an exemplary embodiment of the present invention. As shown in FIG. 1, a botnet is configured by computers (zombies) 120 and 130 that are infected by a plurality of networked bots and a C&C server 110 that commands and controls the computers. As shown in FIG. 1, the botnet may have a centralized structure 140 or a distributed structure 150 or a hybrid structure combining the centralized structure and the distributed structure.

In such a botnet structure, the infected bots use a DNS service in order to communicate with the C&C server. The hots uses the DNS service because if a fixed IP address of the C&C is allocated, IP tracking can easily block the C&C server by a copying method such as forcibly blocking the corresponding IP address. In order to avoid the copying method, attackers use the DNS service so that the plurality of bots access the C&C server through a domain address. Further, if as a more advanced method, a DDNS (dynamic DNS) service Fast-Flux technology in which an IP address corresponding to the domain name continuously changes is used, it is more difficult to detect the C&C server.

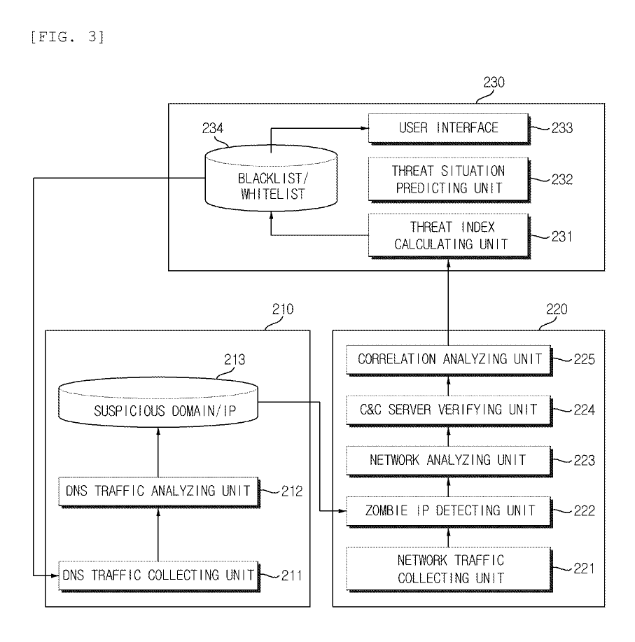

FIG. 2 shows a configuration of a cyber threat prior prediction apparatus according to an exemplary embodiment of the present invention. The cyber threat prior prediction apparatus according to the exemplary embodiment includes a DNS based C&C server detecting unit 210, a network based abnormality detecting unit 220, and a cyber threat predicting unit 230.

The DNS based C&C server detecting unit 210 is provided on a DNS server or DNS server farm and analyzes DNS traffic to extract a domain address which is suspected as a C&C server. The DNS based C&C server detecting unit 210 may be applied to an ISP (Internet service provider) network and a DNS server group area of a local network. The DNS based C&C server detecting unit 210 transmits a DNS query to the DNS server to obtain an IP address of a suspicious domain address which is extracted.

The network based abnormality detecting unit 220 analyzes network traffic based on a network to detect IP addresses of zombie PCs that access the suspicious C&C server extracted by the DNS based C&C server detecting unit 210, verify the C&C server based on the access information of the zombie PCs, and detect network structure based threat information and activity based threat information of the C&C server and the zombie PCs. The network based abnormality detecting unit 220, as shown in FIG. 2, is installed in an international gateway network to analyze network traffic which passes through the international gateway network. The C&C server is mainly based in an overseas country and commands/controls bots based domestically. Therefore, the network based abnormality detecting unit 220 is installed in the international gateway network to efficiently detect the bots which communicate with the C&C server.

The cyber threat predicting unit 230 quantifies the possibility of cyber threat based on the network structure based threat information and the activity based threat information detected by the network based abnormality detecting unit 220, calculates a quantified threat index, and predicts a cyber threat situation using the quantified threat index. Further, the cyber threat predicting unit 230 provides the information on the cyber threat situation to a manager and predicts/warns the threat situation. By using the cyber threat predicting unit 230, it is possible to predict/warn the cyber threat by previously recognizing the cyber threat over a global network before an attack.

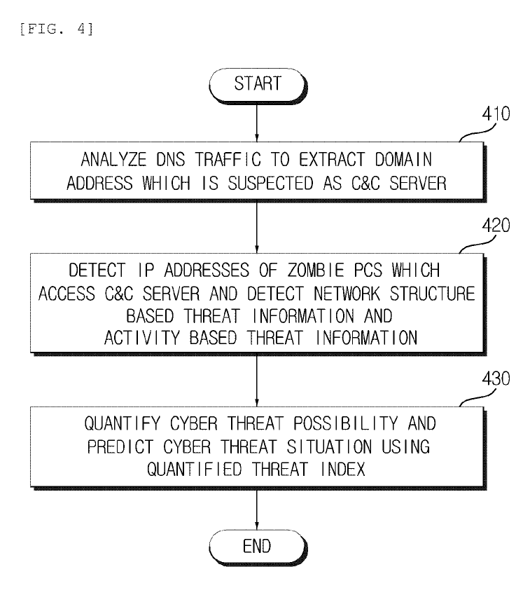

FIG. 3 shows a more specific configuration of a cyber threat prior prediction apparatus according to an exemplary embodiment of the present invention. The DNS based C&C server detecting unit 210 includes a DNS traffic collecting unit 211, a DNS traffic analyzing unit 212, and a suspicious domain/IP database 213. The network based abnormality detecting unit 220 includes a network traffic collecting unit 221, a zombie IP detecting unit 222, a network analyzing unit 223, a C&C server verifying unit 224, and a correlation analyzing unit 225. The cyber threat predicting unit 230 includes a threat index calculating unit 231, a threat situation predicting unit 232, a user interface 233, and a blacklist/whitelist database 234.

In the DNS based C&C server detecting unit 210, the DNS traffic collecting unit 211 collects DNS traffic and creates a DNS traffic data set. The blacklist/whitelist database 234 contains known blacklist domain and whitelist domain information. The DNS traffic collecting unit 211 may filter the collected DNS traffic using the blacklist domain information and the whitelist domain information in order to collect a large quantity of DNS queries and create a data set.

The DNS traffic analyzing unit 212 analyzes the collected DNS traffic and extracts a domain address which is suspected as a C&C server. The DNS traffic analyzing unit 212 may analyze the DNS traffic based on a domain, or based on traffic characteristics, or based on N-tier. Further, the DNS traffic analyzing unit 212 may analyze the DNS traffic by combining two or more analyzing methods.

In a case of analyzing based on a domain, an N-gram algorithm or a ZipFian algorithm may be used. The above algorithms extract a domain address configured by a combination of characters which are not normally used as a domain address. In a case of analyzing based on traffic characteristics, characteristics of botnets using DDNS or Fast-Flux which have very short TTL (time to live) and establish access having similar patterns or an instantly large quantity of access are analyzed. Since botnets have various kinds of structures, it is efficient to combine various analyzing methods rather than one analyzing method. An advanced C&C server and bots pretend that access patterns are random, but these C&C server and bots are commanded/controlled by an infected bot, which is different from a normal user. Accordingly, the C&C server and bots may have a specific pattern. The DNS traffic analyzing unit 212 analyzes a DNS query transmitted/received to/from the DNS server to obtain an IP address of a domain address of a suspicious C&C server from the DNS traffic which inquires in a specific pattern. The domain address and the IP address of the suspicious DNS server are stored in the suspicious domain/IP database 213.

In the network based abnormality detecting unit 220, the network traffic collecting unit 221 collects the network traffic.

The zombie IP detecting unit 222 detects IP addresses of zombie PCs (hereinafter, referred to as zombie IP) that access the suspicious C&C server using the domain address and the IP address of the suspicious C&C server from the collected network traffic.

The network analyzing unit 223 detects access information of the detected zombie PC such as an access type, an access status, an access frequency, or an access pattern and detects the communication type of the zombie PC that accesses the domain address of the suspicious C&C server based on a network. Further, the network analyzing unit 223 analyzes similarity of network activity between zombie PCs that access the domain address of the suspicious C&C server.

The C&C server verifying unit 224 verifies the suspicious C&C servers detected by the DNS based C&C server detecting unit 210 based on the result analyzed by the network analyzing unit 223, that is, the access information and the communication type of the zombie PC and similarity of network activity between zombie PCs. Specifically, the C&C server verifying unit 224 determines the abnormality of network activity between the suspicious C&C server and the zombie PCs based on the result analyzed by the network analyzing unit 223 and classifies a C&C server and a zombie PC which are determined to be abnormal into an active status and a C&C server and a zombie PC which are determined to be normal into an de-active status.

The correlation analyzing unit 225 analyzes the correlation between the C&C server and the zombie PC which are classified into an active status. If the network based abnormality detecting unit 220 is applied to the international gateway network, it is possible to analyze the correlation between a C&C server which is based in an overseas country and bots which are based domestically.

The correlation analyzing unit 225 calculates a bot size of the corresponding C&C server, an access frequency of hots to the C&C server, and propagation degree of the bots in ISP domains as correlation between the C&C server and the zombie PCs. The above-mentioned information will be specifically described as follows, and refers to information indicating network structure based threats of the C&C server and the bots.

1. Bot size B_{size}: the number of bots of all ISP domains which access the corresponding C&C server

2. Access frequency (frequency between C&C and bots) B_{frequency}: the number of times accessing of hots to the corresponding C&C server

3. Number of bots which are propagated to the ISP domains Bₚ: the number of propagated bots per ISP domain (Bₚ≦B_{size})

Further, the correlation analyzing unit 225 analyzes the activity of active hots. The correlation analyzing unit 225 analyzes contents of a command and control message packet which is transmitted from the C&C server to the zombie PCs to detect malicious activity of the bots. The activity of the bots is classified into a spam attack activity, a scan attack activity, a binary code download activity, and an exploiting activity. Therefore, the activity of the bots may be described as follows, and corresponds to information indicating activity based threats of the C&C server and the bots.

1. None (Wₙ): no activity

2. Spam (W ₛₚₐₘ)

3. Scan (W_{scan})

4. Binary code downloading (W_{Binary})

5. Attacking vulnerability (W_{E})

A weight may be applied to each of the activities depending on the degree of risk. Generally, the attack of vulnerability is riskier than the spam attack. For example, the weight may be applied as follows: Wₙ=1, Wₛₚₐₘ=2, W_{scam}=3, W_{Binary}=4, and W_{E}=5.

The correlation analyzing unit 225 transmits information concerning the bot size, the access frequency, and the number of bots propagated to the ISP domains and activity information of the bots which are obtained above to the cyber threat predicting unit 230.

The DNS traffic analyzing unit 212 and the network based abnormality detecting unit 220 may be installed per plural DNS server farms and plural international gateway networks, and the cyber threat predicting unit 230 receives and combines information from the plural DNS traffic analyzing unit 212 and the plural network based abnormality detecting unit 220 to predict the threat situation of a global network.

In the cyber threat predicting unit 230, the threat index calculating unit 231 quantifies the cyber threat possibility based on the information received from the network based abnormality detecting unit 220 to calculate a quantified threat index. The threat index calculating unit 231 may calculate the following threat index.

1. Degree of threat (D_{T})

$${D}_{T} = {\sum }_{\text{?}}^{\text{?}} {W}_{j} ( {B}_{\text{?}} \times \frac{{B}_{\text{?}}}{AVG ( {B}_{\text{?}} )} ) ( \text{?} ( \text{?} ) , Wi \geq 1 )$$

$$\text{?} \text{indicates text missing or illegible when filed}$$

2. Degree of vulnerability of ISP domain (V_{ISP})

$$\frac{{B}_{\text{?}}}{{B}_{\text{?}}} < 1$$

$$\text{?} \text{indicates text missing or illegible when filed}$$

(corresponding ISP domain becomes more vulnerable as approaches to 1)

Here, the degree of threat (D_{T}) indicates the degree of threat of a global network. If the degree of threat (D_{T}) is calculated for a specific ISP domain, the degree of threat (D_{T}) refers to a degree of threat of the corresponding ISP domain.

The threat situation predicting unit 232 uses the threat index calculated by the threat index calculating unit 231 to predict the threat situation. For example, the threat situation predicting unit 232 compares the degree of threat (D_{T}) or the degree of vulnerability of ISP domain (V_{ISP}) with a threshold, and if the degree of threat (D_{T}) or the degree of vulnerability of ISP domain (V_{ISP}) exceeds the threshold, determines that there is a threat possibility. In another example, the level of threat possibility may be defined according to the range of the degree of threat (D_{T}) or the degree of vulnerability of ISP domain (V_{ISP}). The threat possibility may be determined for the global network or for a specific ISP domain.

The user interface 233 visualizes and displays the threat situation predicted by the threat situation predicting unit 232 so as to be recognized by the user or a manager. In another example, the user interface 233 may issue forecasting/warning using sound in addition to the visualized display.

As described above, the blacklist/whitelist database 234 stores a known blacklist domain and whitelist domain address. The domain address of the active C&C server detected by the network based abnormality detecting unit 220 is updated as a blacklist domain of the blacklist/whitelist database 234. Further, the blacklist domain and the whitelist domain may be provided to the user or the manager through the user interface 233.

FIG. 4 is a flowchart of a cyber threat prior prediction method according to an exemplary embodiment of the present invention. The cyber threat prediction method is configured by steps processed in the above-described cyber threat prediction apparatus. The above description of the cyber threat prior prediction apparatus may be also applied to a cyber threat prior prediction method according to this embodiment even though it is omitted in this embodiment.

In step 410, the DNS based C&C server detecting unit 210 analyzes the DNS traffic to extract a domain address which is suspected as the C&C server.

In step 420, the network based abnormality detecting unit 220 detects IP addresses of zombie PCs which access the suspicious C&C server detected in step 410, verifies the C&C server based on the access information of the zombie PCs, and detects the network structure based threat information and activity based threat information of the C&C server and the zombie PCs.

In step 430, the cyber threat predicting unit 230 quantifies the cyber threat possibility based on the network structure based threat information and the activity based threat information detected in step 420 to calculate the quantified threat index and predict the cyber threat situation using the quantified threat index.

In the above described invention, at first, a suspicious C&C server is detected by DNS analysis and then secondarily, the abnormality of network traffic is detected based on the network to verify the suspicious C&C server. The network based abnormality detection is efficiently applied to the international gateway network or international interworking network in consideration that the C&C server is mainly based in the overseas country and commands/controls bots based domestically. Therefore, by the network based abnormality detection, it is possible to verify the C&C server in real time basis through the network based abnormality detection and detect bots which are communicating with the C&C server.

The above invention may be applied regardless of the structure of botnet and efficiently operated when the C&C server is based in the overseas country. Further, since the malicious domain is extracted based on the DNS traffic, the suspicious targets may be reduced. Further, the cyber threat situation may be previously recognized based on the botnet detection.

The exemplary embodiments of the present invention may be provided as programs that can be executed in a computer, and embodied in a general purpose digital computer that operates the program using a computer readable recording medium. Examples of the computer readable recording medium include a storage medium such as a magnetic storage medium (for example, a ROM, a floppy disk, a hard disk, etc.) and an optical readable medium (for example, CD-ROM, DVD, etc.).

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A cyber threat prior prediction apparatus, comprising:
a DNS based C&C server detecting unit configured to analyze DNS traffic to extract a domain address which is suspected as a C&C server;
a network based abnormality detecting unit configured to analyze the network traffic to detect IP addresses of zombie PCs which access the C&C server and information of the zombie PCs; and
a cyber threat predicting unit configured to predict a cyber threat situation based on the information of the zombie PCs.

2. The apparatus of claim 1, wherein the network based abnormality detecting unit is installed in an international gateway network.

3. The apparatus of claim 1, wherein the DNS based C&C server detecting unit analyzes the DNS traffic based on a domain address, traffic characteristics, or N-tier.

4. The apparatus of claim 1, wherein the network based abnormality detecting unit detects access information of the zombie PCs to the C&C server.

5. The apparatus of claim 1, wherein the network based abnormality detecting unit verifies the C&C server based on the access information of the zombie PCs to the C&C server.

6. The apparatus of claim 1, wherein the network based abnormality detecting unit detects network structure based threat information and activity based threat information of the zombie PCs.

7. The apparatus of claim 6, wherein the network structure based threat information includes a bot size, an access frequency of hots, or the number of bots which are propagated to the ISP domains.

8. The apparatus of claim 6, wherein the activity based threat information includes a spam attack activity, a scan attack activity, a binary download activity, or an exploiting activity.

9. The apparatus of claim 6, wherein the cyber threat predicting unit predicts a cyber threat situation based on the network structure based threat information and the activity based threat information.

10. The apparatus of claim 6, wherein the cyber threat predicting unit calculates a threat index quantified based on the network structure based threat information and the activity based threat information and predicts the cyber threat situation using the quantified threat index.

11. A cyber threat prior prediction method, comprising:
analyzing DNS traffic to extract a domain address which is suspected as a C&C server;
analyzing network traffic to detect IP addresses of zombie PCs which access the C&C server and information of the zombie PCs; and
predicting a cyber threat situation based on the information of the zombie PCs.

12. The method of claim 11, wherein the detecting of information of zombie PCs analyzes network traffic of an international gateway network.

13. The method of claim 11, wherein the detecting of information of zombie PCs includes:
detecting access information of the zombie PCs to the C&C server.

14. The method of claim 11, wherein the detecting of information of zombie PCs includes:
verifying the C&C server based on access information of the zombie PCs to the C&C server.

15. The method of claim 11, wherein the detecting of information of zombie PCs includes:
detecting network structure based threat information and activity based threat information of the zombie PCs.

16. The method of claim 15, wherein the predicting of cyber threat situation includes:
predicting the cyber threat situation based on the network structure based threat information and the activity based threat information.

17. The method of claim 15, wherein the predicting of cyber threat situation includes:
calculating a threat index quantified based on the network structure based threat information and the activity based threat information; and
predicting the cyber threat situation using the quantified threat index.
